(19) United States
(12) Patent Application Publication
(10) Pub. No.: US 2024/0024777 A1
(43) Pub. Date: Jan. 25, 2024

(54) NON-TRANSITORY COMPUTER-READABLE STORAGE MEDIUM, SYSTEM, AND METHOD

(71) Applicant: NINTENDO CO., LTD., Kyoto-shi (JP)

(72) Inventor: Shintaro SATO, Kyoto-shi (JP)

(21) Appl. No.: 18/341,185

(22) Filed: Jun. 26, 2023

(30) Foreign Application Priority Data
Jul. 21, 2022 (JP) 2022-116557

(51) Int. Cl. A63F 13/55

(52) U.S. Cl. CPC A63F 13/55

(57) ABSTRACT

A program that causes a computer to execute an application based on communication between/among a plurality of users causes the computer to function as first game execution means for executing a first game that increases a first parameter, second game execution means for executing a second game when an execution condition is satisfied, and determination means for determining whether or not there is a record of a second application. When the first parameter is in a prescribed state or when there is a record, the execution condition is determined as being satisfied.

This nonprovisional application claims priority on Japanese Patent Application No. 2022-116557 filed on Jul. 21, 2022 with the Japan Patent Office, the entire contents of which are hereby incorporated by reference.

### FIELD

The present disclosure relates to a program, a system, and a method.

### BACKGROUND AND SUMMARY

Among applications that provide a communication game executed between/among a plurality of users, for example, there is an application that increases a parameter set for each user based on execution of the communication game.

In such an application, the above-described parameter set for the user may be used to make determination as to a condition for execution of a specific game that has not been executable in an initial state. For example, it has been known that a parameter “rank” that increments one by one as a battle is fought in a match over the Internet is set for each user and a specific game is executable when the rank reaches ten.

Among users who newly execute such an application, however, there are some users who have already learnt a basic operation method. In an example where applications are available in a series form, a user who has experienced play of other applications under the series may desire execution of a specific game immediately after execution of a new application.

The present disclosure can realize a scheme for allowing a user estimated to have experienced a game to execute a specific game early in an application that provides a communication game.

(Configuration 1) An exemplary embodiment provides a non-transitory computer-readable storage medium with an executable program stored thereon, the program causing one or more processors to execute a first application including at least a first game and a second game based on communication between/among a plurality of users. The program causes the one or more processors to perform executing the first game that at least increases a first parameter relating to user play, executing the second game when an execution condition is satisfied, determining whether there is a record at least indicating possession or execution by a user of a second application different from the first application, and determining that the execution condition is satisfied at least when the first parameter is in a prescribed state or at least when it is determined that the record is present.

According to Configuration 1, a scheme for allowing a user estimated to have experienced a game to execute a specific game early in an application that provides a communication game can be realized. Since the user estimated to have experienced the game is allowed to play the second game in addition to the first game, the number of options of games which the player estimated to have experienced the game can execute increases. In other words, possibility of play of the first game by the player estimated to have experienced the game becomes low. Consequently, a ratio of users other than the user estimated to have experienced the game among users who play the first game, that is, users estimated to have no or few experiences of play of the game, is estimated to increase. Thus, in the application in the present embodiment, matching between users estimated to have no or few experiences of the game can be facilitated.

(Configuration 2) In Configuration 1, the second application includes a third game and a fourth game based on communication between/among the plurality of users, the third game increases a second parameter relating to user play, and the fourth game is executable when the second parameter is in a prescribed state.

According to Configuration 2, when there is a record, the user can be estimated to have an experience that can be applied to the first application.

(Configuration 3) In Configuration 2, the program causes the one or more processors to perform determining that the execution condition is satisfied regardless of whether the record indicates that the fourth game has been executable by the user.

According to Configuration 3, if the user can be estimated to at least have an experience, the user can execute the second game.

(Configuration 4) In Configuration 2 or 3, the second game at least increases a first level parameter indicating a skill of a user with a plurality of classes, and is executed by matching of users in an identical class of the first level parameter. The fourth game at least increases a second level parameter indicating a skill of a user with a plurality of classes, and is executed by matching of users in an identical class of the second level parameter. The record includes information on the second level parameter. The program causes the one or more processors to perform determining a class in the first level parameter of the user based on the information on the second level parameter.

According to Configuration 4, in a system 10, a skill of the user in a second application A2 is reflected on a first level parameter Lp1 indicating a skill of the user in first application A1.

(Configuration 5) In Configuration 4, the program causes the one or more processors to perform determining, when a class in the second level parameter included in the record is not a lowest class among the plurality of classes, the class in the first level parameter as a prescribed class higher than the lowest class and lower than a highest class among the plurality of classes.

According to Configuration 5, in system 10, the skill of the user in first application A1 can be determined based on the skill of the user in second application A2.

(Configuration 6) In any one of Configurations 1 to 5, the program causes the one or more processors to perform determining that the execution condition is satisfied when it is determined that the record is present and furthermore when the user executed the first game at least once.

According to Configuration 6, the user is caused to execute the first game at least once.

(Configuration 7) Another exemplary embodiment provides a system that executes a first application including at least a first game and a second game based on communication between/among a plurality of users. The system includes a memory storing a computer-readable program and one or more processors that perform, when executing the computer-readable program, executing the first game that at least increases a first parameter relating to user play, executing the second game when an execution condition is satisfied, determining whether there is a record at least indicating possession or execution by a user of a second application different from the first application, and determining that the execution condition is satisfied at least when the first parameter is in a prescribed state or at least when it is determined that the record is present.

(Configuration 8) In Configuration 7, the second application includes a third game and a fourth game based on communication between/among the plurality of users, the third game increases a second parameter relating to user play, and the fourth game is executable when the second parameter is in a prescribed state.

According to Configuration 8, when there is a record, the user can be estimated to have an experience that can be applied to the first application.

(Configuration 9) In Configuration 8, one or more processors perform, when executing the computer-readable program, determining that the execution condition is satisfied regardless of whether the record indicates that the fourth game has been executable by the user.

According to Configuration 9, if the user can be estimated to at least have an experience, the user can execute the second game.

(Configuration 10) In Configuration 8 or 9, the second game at least increases a first level parameter indicating a skill of a user with a plurality of classes, and is executed by matching of users in an identical class of the first level parameter. The fourth game at least increases a second level parameter indicating a skill of a user with a plurality of classes, and is executed by matching of users in an identical class of the second level parameter. The record includes information on the second level parameter. One or more processors perform, when executing the computer-readable program, determining a class in the first level parameter of the user based on the information on the second level parameter.

According to Configuration 10, in system 10, a skill of the user in second application A2 is reflected on first level parameter Lp1 indicating a skill of the user in first application A1.

(Configuration 11) In Configuration 10, one or more processors perform, when executing the computer-readable program, determining, when a class in the second level parameter included in the record is not a lowest class among the plurality of classes, the class in the first level parameter as a prescribed class higher than the lowest class and lower than a highest class among the plurality of classes.

According to Configuration 11, in system 10, the skill of the user in first application A1 can be determined based on the skill of the user in second application A2.

(Configuration 12) In any one of Configurations 7 to 11, one or more processors perform, when executing the computer-readable program, determining that the execution condition is satisfied when it is determined that the record is present and furthermore when the user executed the first game at least once.

According to Configuration 12, the user is caused to execute the first game at least once.

(Configuration 13) Another exemplary embodiment provides a method of causing one or more processors to execute a first application including at least a first game and a second game based on communication between/among a plurality of users. The method includes executing the first game that at least increases a first parameter relating to user play, executing the second game when an execution condition is satisfied, determining whether there is a record at least indicating possession or execution by a user of a second application different from the first application, and determining that the execution condition is satisfied at least when the first parameter is in a prescribed state or at least when it is determined that the record is present.

(Configuration 14) In Configuration 13, the second application includes a third game and a fourth game based on communication between/among the plurality of users, the third game increases a second parameter relating to user play, and the fourth game is executable when the second parameter is in a prescribed state.

According to Configuration 14, when there is a record, the user can be estimated to have an experience that can be applied to the first application.

(Configuration 15) In Configuration 14, the method includes determining that the execution condition is satisfied regardless of whether the record indicates that the fourth game has been executable by the user.

According to Configuration 15, if the user can be estimated to at least have an experience, the user can execute the second game.

(Configuration 16) In Configuration 14 or 15, the second game at least increases a first level parameter indicating a skill of a user with a plurality of classes, and is executed by matching of users in an identical class of the first level parameter. The fourth game at least increases a second level parameter indicating a skill of a user with a plurality of classes, and is executed by matching of users in an identical class of the second level parameter. The record includes information on the second level parameter. The method includes determining a class in the first level parameter of the user based on the information on the second level parameter.

According to Configuration 16, in system 10, a skill of the user in second application A2 is reflected on first level parameter Lp1 indicating a skill of the user in first application A1.

(Configuration 17) In Configuration 16, the method includes determining, when a class in the second level parameter included in the record is not a lowest class among the plurality of classes, the class in the first level parameter as a prescribed class higher than the lowest class and lower than a highest class among the plurality of classes.

According to Configuration 17, in system 10, the skill of the user in first application A1 can be determined based on the skill of the user in second application A2.

(Configuration 18) In any one of Configurations 13 to 17, the method includes determining that the execution condition is satisfied when it is determined that the record is present and furthermore when the user executed the first game at least once.

According to Configuration 18, the user is caused to execute the first game at least once.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing illustrating an exemplary system according to the present embodiment.

FIG. 2 shows an exemplary illustrative non-limiting drawing illustrating an exemplary application.

FIG. 3 shows an exemplary illustrative non-limiting drawing illustrating an exemplary hardware configuration of a terminal included in the system according to the present embodiment.

FIG. 4 shows an exemplary illustrative non-limiting drawing illustrating a flowchart showing a procedure in main processing.

FIG. 5 shows an exemplary illustrative non-limiting drawing illustrating a flowchart showing a procedure in on-line connection processing.

FIG. 6 shows an exemplary illustrative non-limiting drawing illustrating a flowchart showing a procedure in processing for setting a second game execution flag.

FIG. 7 shows an exemplary illustrative non-limiting drawing illustrating an exemplary screen showing that ban on execution of a second game is removed as a result of takeover processing.

FIG. 8 shows an exemplary illustrative non-limiting drawing illustrating an exemplary screen showing that ban on execution of the second game is removed as a first rank reaches “rank 10.”

FIG. 9 shows an exemplary illustrative non-limiting drawing illustrating a flowchart showing a procedure in takeover processing.

FIG. 10 shows an exemplary illustrative non-limiting drawing illustrating a flowchart showing a procedure in game quitting processing.

FIG. 11 shows an exemplary illustrative non-limiting drawing illustrating another exemplary system according to the present embodiment.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

[A. Overview]

An exemplary configuration of a system that executes an application that provides a communication game according to the present embodiment will initially be described.

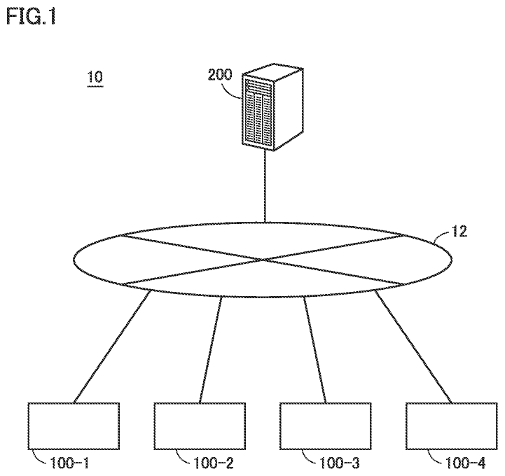

FIG. 1 is a schematic diagram showing an exemplary system according to the present embodiment. FIG. 1 shows a system 10 composed of four terminals 100-1 to 100-4 (which may also collectively be referred to as a “terminal 100” below) and a server 200 by way of example.

In system 10 shown in FIG. 1, each of four terminals 100-1 to 100-4 is connected to a network 12. Server 200 that performs at least a part of processing necessary for a communication game is connected to network 12. Terminals 100-1 to 100-4 execute the communication game with server 200 being interposed. In the present embodiment, server 200 manages user information.

Terminals 100-1 to 100-4 are each an exemplary information processing apparatus, and execute a communication game with communication. In other words, each of terminals 100 executes the communication game with communication with another terminal 100.

In system 10 shown in FIG. 1, communication for connection of terminals 100-1 to 100-4 to network 12 may be wired or wireless. Alternatively, server 200 shown in FIG. 1 may be eliminated and terminals 100-1 to 100-4 may communicate with one another over network 12.

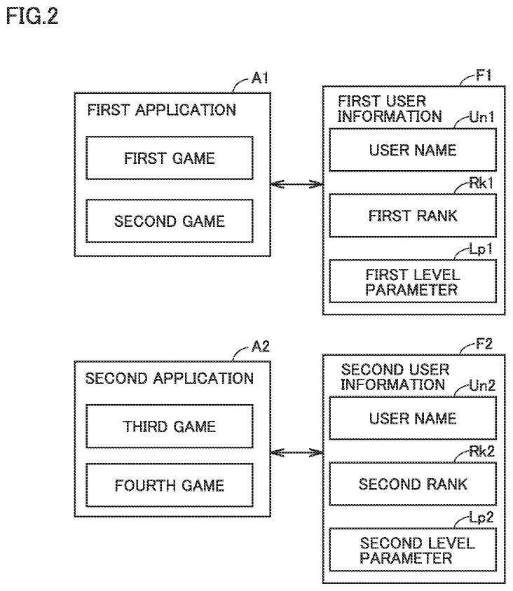

FIG. 2 is a diagram showing exemplary first and second applications. Each of a first application A1 and a second application A2 provides a communication game. First application A1 is executed by terminals 100-1 to 100-4. Second application A2 may be executed by terminals 100-1 to 100-4 similarly to first application A1 or may be executed by another terminal different from terminal 100. The “communication game” herein encompasses a game in which one or more users are involved, and any kind of game is applicable.

For example, the communication game may include a game in which a plurality of users can participate in a virtual space. By way of example, the communication game may include a user-versus-user game or a game in which a plurality of users cooperate. A non-player character operated by a computer may participate in the communication game. Though first application A1 and second application A2 that allow execution of the communication game are described below, when the “communication game” is simply referred to herein, the communication game includes both of a communication game executed by first application A1 and a communication game executed by second application A2.

First application A1 and second application A2 are, for example, applications belonging to the same series. First application A1 uses first user information F1 and second application A2 uses second user information F2. In the present embodiment, second user information F2 in second application A2 and first user information F1 in first application A1 are stored as cloud data in server 200. In the present embodiment, second application A2 is released earlier than first application A1. In other words, when first application A1 is executed, second user information F2 has already been stored in server 200.

The communication game in first application A1 and the communication game in second application A2 may be common in basic actions in the game. The basic actions in the game include, for example, a moving action, a jumping action, and a main attack action by a character. The basic actions in the game may include an auxiliary attack action by a character, a defense action, an action to avoid an attack, an action to hide the character itself, and an action affecting an object in the virtual space.

In a method of operating an operation portion 108 for performing these actions, for example, a method of operating a character may be common between the communication game in first application A1 and the communication game in second application A2. More specifically, for example, when operations in the communication game in first application A1 and the communication game in second application A2 can be performed with the use of the same controller, actions in the games performed at the time when a stick or a button in the controller is operated may be common. Alternatively, operations in the communication game in first application A1 and the communication game in second application A2 may be performed with the use of controllers of the same type. At this time, actions in the games in first application A1 and second application A2 performed when a corresponding stick or button is operated may be common. The controllers of the same type means that one controller and the other controller are similar in position of arrangement of an operation portion the same in type, such as a button or a stick. The other controller may include an operation portion such as an additional button or a function in addition to that in one controller.

In system 10 according to the present embodiment, each of four terminals 100-1 to 100-4 executes first application A1. Terminal 100 executes first application A1, for example, by attachment thereto of an externally attachable recording medium where data for execution of first application A1 is stored. Alternatively, application data for execution of first application A1 may be downloaded in advance to terminal 100 through the Internet or the like.

First application A1 includes a first game and a second game as the communication games. In other words, types of games executable by first application A1 include the first game and the second game. The first game is a game executable from the time when first application A1 is in an initial state. The second game, on the other hand, is a game executable only when an execution condition is satisfied. In other words, only a user who satisfies the execution condition among users who execute first application A1 can execute the second game.

First user information F1 shown in FIG. 2 is information used in the communication game in first application A1 and includes a user name Un1, a first rank Rk1, and a first level parameter Lp1.

User name Un1 is identification information of a user shown in the communication game executed by first application A1. User name Un1 may be inputted by the user, for example, when first application A1 is executed for the first time. User name Un1 is, for example, any character string including numerals, alphabet, and/or signs. A user account name set for each terminal where first application A1 is executed may be used as user name Un1.

First rank Rk1 is a parameter relating to user play. First rank Rk1 is a parameter that increases, for example, with a time period of play of the communication game, the number of times of execution of the communication game, and/or contribution in the communication game. The contribution in the communication game is determined, for example, by evaluation of actions in the communication game or evaluation of results of the actions. First rank Rk1 corresponds to the “first parameter” in the present disclosure.

In the present embodiment, first rank Rk1 is a value expressed, for example, by numerals from one to one hundred, and it is incremented one by one. The initial state of first rank Rk1 is expressed as “rank 1.” Exemplary values that may be stored as first rank Rk1 include “rank 5,” “rank 20,” and “rank 90.” When first rank Rk1 is shown to other users, other users can infer from first rank Rk1, the total time period of play of the communication game by the user for which first rank Rk1 is shown or the skill of the user.

A degree of difficulty in increase by one in first rank Rk1 is higher as first rank Rk1 increases. Specifically, the degree of difficulty in increase in first rank Rk1 from “rank 99” to “rank 100” is higher than the degree of difficulty in increase in first rank Rk1 from “rank 1” to “rank 2.” In other words, in first application A1, when a value of first rank Rk1 is small, first rank Rk1 is more easily increased, whereas when the value of first rank Rk1 is large, first rank Rk1 is more difficult to be increased.

By way of example, first application A1 in the present embodiment may be set such that the number of times of execution of the game necessary for increase in first rank Rk1 from “rank 99” to “rank 100” is larger than the number of times of execution of the game necessary for increase in first rank Rk1 from “rank 1” to “rank 2.”

In the present embodiment, a condition for execution of the second game includes first rank Rk1 reaching “rank 10” or higher. “Rank 10” represents an exemplary “prescribed state” in the present disclosure. The user, first rank Rk1 of which is “rank 10” or higher, can execute the second game. In other words, the user can satisfy the condition for execution of the second game by increasing first rank Rk1 by executing the first game executable from the initial state.

In first application A1, an area of the virtual space where the user is movable may be made larger in accordance with the value of first rank Rk1. Alternatively, in first application A1, the number of types of items available to the user in the game may be increased in accordance with the value of first rank Rk1. In first application A1, an item or a currency available in the game may be given to the user each time the value of first rank Rk1 increases.

First level parameter Lp1 is a parameter that expresses the skill of the user with a plurality of classes. First level parameter Lp1 is used, for example, for a match between users comparable in skill, based on classification of users in accordance with the skill of the users.

In the present embodiment, first level parameter Lp1 is of a data type including such classes as a first class, a second class, and a third class. The class means each category included in the data type of first level parameter Lp1. The first class refers to a class indicating the lowest skill and the third class refers to a class indicating the highest skill. The second class refers to a class indicating the skill intermediate between the first class and the third class.

In first application A1, for example, users, the class in first level parameter Lp1 of which is the first class, play against each other in the communication game. Thus, in first application A1, a match between users comparable in skill can be provided. The classes included in first level parameter Lp1 are not limited to three classes, and, for example, five or ten classes may be set. The class included in first level parameter Lp1 may further be subclassified, and for example, a 1-1st class, a 1-2nd class, and a 1-3rd class may further be included in the first class. Even when the first class is subclassified into the 1-1st class, the 1-2nd class, and the 1-3rd class, in first application A1, matching of users included in one of the 1-1st class, the 1-2nd class, and the 1-3rd class may be made in the first class. In other words, in first application A1, users included in one of the 1-1st class, the 1-2nd class, and the 1-3rd class compete against each other.

Second user information F2 is information used in the communication game in second application A2, and includes a user name Un2, a second rank Rk2, and a second level parameter Lp2. User name Un2, second rank Rk2, and second level parameter Lp2 in second application A2 correspond to user name Un1, first rank Rk1, and first level parameter Lp1 in first application A1, respectively. For example, user name Un2, second rank Rk2, and second level parameter Lp2 are identical in data type to user name Un1, first rank Rk1, and first level parameter Lp1, respectively.

Each of user name Un1 and user name Un2 is, for example, of the data type where any character string can be stored. Each of first rank Rk1 and second rank Rk2 is of the data type where at least an integer is countable. Furthermore, each of first level parameter Lp1 and second level parameter Lp2 is of the data type where a user can be categorized into a plurality of classes. Data stored under user name Un1 can be stored also under user name Un2. Data stored under first rank Rk1 can be stored also under second rank Rk2. Data stored under first level parameter Lp1 can be stored also under second level parameter Lp2. In other words, data included in second user information F2 can readily be converted to data in corresponding first user information F1.

When second application A2 is executed in terminal 100, application data for execution of second application A2 may be stored, for example, in an externally attachable recording medium and the second application may be executed as the recording medium is attached to terminal 100 similarly to first application A1, or the second application may be executed by being downloaded to terminal 100 through the Internet or the like. Second application A2 may be executed also from a terminal other than terminal 100. From whichever terminal second application A2 may be executed, second user information F2 is stored in server 200 at the time of on-line connection. In other words, second application A2 generates second user information F2 on server 200 as being triggered by on-line connection. Second application A2, however, may generate second user information F2 on server 200 only after a third game is executed. In this case, only second user information F2 of the user who has the experience of execution of the third game is stored in server 200. Second user information F2 generated on server 200 is thereafter updated as appropriate as second application A2 runs. For example, second user information F2 may be updated each time the third game or a fourth game starts or ends. In other words, second user information F2 performs a function as save data.

Server 200 stores first user information F1 and second user information F2 of a plurality of users and totally manages user information in first application A1 and second application A2. A user can access only first user information F1 and second user information F2 corresponding to the user himself/herself. In other words, server 200 identifies the user based on a password or the like and allows only the authenticated user to use first user information F1 and second user information F2 corresponding to the user.

The third game and the fourth game included in second application A2 correspond to the first game and the second game included in first application A1, respectively. In other words, the third game is a game executable in the initial state of second application A2, whereas the fourth game is a game executable only when the execution condition is satisfied. Only the user who satisfies the execution condition among users who execute second application A2 can execute the fourth game.

The condition for execution of the fourth game includes second rank Rk2 reaching “rank 10” or higher. The user, second rank Rk2 of which is “rank 10” or higher, can execute the fourth game. In other words, the user can satisfy the condition for execution of the fourth game by increasing second rank Rk2 by executing the third game executable from the initial state.

[B. Rules in First Game to Fourth Game]

Rules in the first game to the fourth game will be described below. In an example where the first game to the fourth game are player-versus-player games, rules of the game may include the number of users who play the game and a condition for winning. The condition for winning may include, for example, magnitude of a degree of influence on the virtual space and the number of beaten users.

The first game and the third game are identical in rules. The second game and the fourth game are identical in rules. The rules in the first game and the third game are different from the rules in the second game and the fourth game. For example, the condition for winning in the first game and the third game may be different from the condition for winning in the second game and the fourth game. The first game and the third game executable form the initial state of the application are referred to as “basic games” below and the second game and the fourth game executable based on satisfaction of an execution condition are referred to as “application games” below.

In the present embodiment, the number of participants in the basic game is different from the number of participants in the application game. In the basic game, for example, a three-on-three team match by six players in total is played. In the application game, for example, a four-on-four team match by eight players in total is played.

In the present embodiment, in the basic game, for example, the degree of influence on the virtual space is competed. In the basic game, a team higher in degree of influence on the virtual space within a limited time period is determined as a winning team. In the application game, on the other hand, for example, in addition to the degree of influence on the virtual space, the number of users beaten in one game is also competed. Alternatively, in the application game, a team that reaches a specific point in the virtual space earlier is determined as the winning team.

Furthermore, in the application game, a weapon and an item unavailable in the basic game may be available. Alternatively, in the virtual space in the application game, an object that is not present in the virtual space in the basic game may be included. The object exerts a special influence in the virtual space in the application game. The application game may include a plurality of types of games. For example, the application game includes a first application game and a second application game; the first application game may be a game in which the number of users beaten in one game is also competed, whereas the second application game may be a game in which a control of a specific object in the virtual space may be competed.

In the application game, for example, matters to which attention should be paid as the winning condition may be complicated for the inexperienced. In an example where the application game includes a plurality of types of games, the application game can be concluded as being more various in rules than the basic game. In other words, the basic game also plays a role as a tutorial including explanation of a basic operation method in playing the application game. Thus, the basic game and the application game in first application A1 and the basic game and the application game in second application A2 are common in at least a part of the operation method and the rules. Second application A2 is released at least earlier than first application A1. Therefore, when the user who has an experience in play of second application A2 executes newly released first application A1, the user may desire early execution of the second game in first application A1.

If the user of first application A1 who has no experience in play of second application A2 also executes the second game early, the less experienced user may be confused due to variousness of game rules.

In first application A1 according to the present embodiment, the less experienced user learns basic operations and rules before the user executes the second game, while the experienced user is allowed to execute the second game early.

[C. Exemplary Hardware Configuration]

An exemplary hardware configuration of an apparatus included in the system according to the present embodiment will now be described.

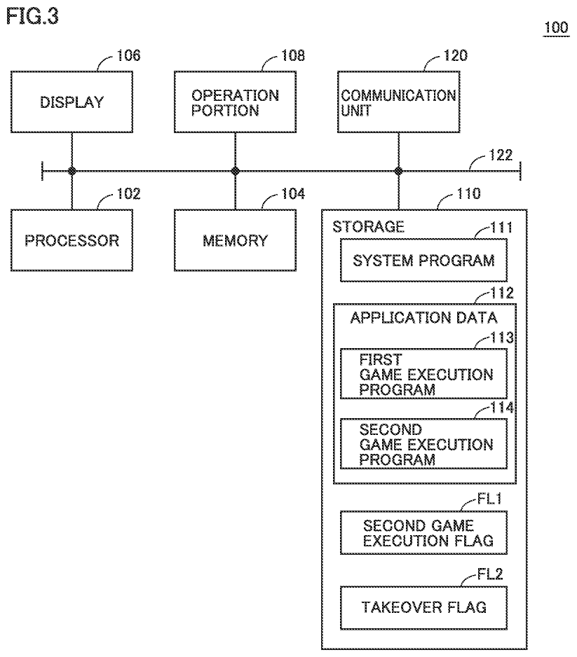

FIG. 3 is a schematic diagram showing an exemplary hardware configuration of terminal 100 included in the system according to the present embodiment. Referring to FIG. 3, terminal 100 is implemented by a computer by way of example, and includes one or more processors 102, a memory 104, a storage 110, a display 106, an operation portion 108, and a communication unit 120. These components are connected to communicate data with one another through a bus 122. Terminal 100 may be implemented by an information processing terminal dedicated for the communication game or by a general-purpose computer.

Processor 102 is a processing entity for performing processing provided by terminal 100. Processor 102 reads a system program 111 and application data 112 stored in storage 110 and first user information F1 stored in server 200, and develops the same on memory 104 for execution.

System program 111, application data 112, a second game execution flag FL1, and a takeover flag FL2 are included in storage 110. Application data 112 includes a first game execution program 113 and a second game execution program 114. First game execution program 113 is a program that implements the first game by being executed by processor 102. Second game execution program 114 is a program that implements the second game by being executed by processor 102.

Second game execution flag FL1 is a flag indicating that the condition for execution of the second game described above is satisfied. When the condition for execution of the second game is satisfied, “ON” is stored in second game execution flag FL1, and when the condition for execution of the second game is not satisfied, “OFF” is stored in second game execution flag FL1. The initial value of second game execution flag FL1 is “OFF.”

Takeover flag FL2 is a flag indicating whether or not the user has permitted takeover. Takeover refers to processing for generating data to be used in first application A1 based on data generated by execution of second application A2, which will be described later in detail. When the user permits takeover, takeover flag FL2 is set to “ON”, and when the user does not permit takeover, takeover flag FL2 is set to “OFF”. The initial value of takeover flag FL2 is “OFF”. The values that can be set for each flag are not limited to “ON” and “OFF”, but may be “True” and “False” or “1” and “0”. Each flag may be set simply based on whether or not data in a file format is present.

Memory 104 is a volatile storage device (storage medium) that can be accessed by processor 102, and for example, a dynamic random access memory (DRAM) or a static random access memory (SRAM) may be employed.

Storage 110 is a non-volatile storage device (storage medium) that can be accessed by processor 102, and a hard disk or a flash memory may be employed. Storage 110 may be, for example, a storage medium attachable to and removable from terminal 100, such as an optical disc and a cartridge.

System program 111 and application data 112 are stored in storage 110. System program 111 and/or application data 112 include(s) an instruction code for implementing processing which will be described later. The “program” that implements processing according to the present embodiment encompasses an instruction code included in system program 111 and/or an instruction code of an application program included in application data 112.

Display 106 shows an image generated as a result of information processing performed by processor 102. Display 106 may be composed of a plurality of displays. One or more external displays may be used by terminal 100.

Operation portion 108 accepts an operation from a user of terminal 100. Operation portion 108 includes, for example, a push button, a control lever, a touch panel, and/or a mouse. Operation portion 108 may be implemented by a game controller which is separate from terminal 100 and connected through a wire or wirelessly.

Communication unit 120 communicates with another terminal 100 and/or server 200 over network 12. Communication unit 120 may include hardware necessary for wired communication and/or hardware necessary for wireless communication. The entirety or a part of processing by communication unit 120 may be performed by processor 102.

Though FIG. 3 shows terminal 100 as an integrated apparatus, the terminal may be implemented as an assembly of a plurality of apparatuses. In other words, terminal 100 may be implemented by combination of a plurality of independent apparatuses. For example, a configuration composed of a main body including hardware corresponding to processor 102, memory 104, and storage 110 and a terminal portion including hardware corresponding to display 106 and operation portion 108 may be adopted.

Processing performed in terminal 100 may be implemented by execution of a program by processor 102, and a part or the entirety of the processing may be implemented by hard-wired circuitry such as an application specific integrated circuit (ASIC) or a field programmable gate array (FPGA).

The term “processor” herein encompasses not only an ordinary meaning of a processing circuit that performs processing in accordance with an instruction code described in a program, such as a central processing unit (CPU), a micro processing unit (MPU), or a graphics processing unit (GPU), but also hard-wired circuitry such as an ASIC or an FPGA. In the hard-wired circuitry such as an ASIC or an FPGA, a circuit corresponding to processing to be executed is formed in advance. Furthermore, the “processor” herein also encompasses circuitry in which a plurality of functions are integrated, such as a system on chip (SoC).

Server 200 is implemented, for example, by a general-purpose computer. Since a hardware configuration of the general-purpose computer has been known, detailed description thereof will not be provided. Though a configuration diagram of hardware in execution of second application A2 is not shown for simplified description, application data in second application A2 includes a third game execution program and a fourth game execution program.

[D. Relation Between Parameter and Communication Game]

Such parameters as first rank Rk1, second rank Rk2, first level parameter Lp1, and second level parameter Lp2 are parameters that can increase as a result of execution of a game. Relation between these parameters and the first game to the fourth game will be described below.

In first application A1, processor 102 executes the first game that can increase at least first rank Rk1 relating to user play by executing first game execution program 113. In other words, processor 102 updates the value of first rank Rk1 based on execution of the first game by executing first game execution program 113.

Processor 102 executes the second game that can increase at least first rank Rk1 relating to user play and first level parameter Lp1 indicating the skill of the user by executing second game execution program 114. In other words, processor 102 updates first rank Rk1 and first level parameter Lp1 based on execution of the second game by executing second game execution program 114. Thus, in the present embodiment, the first game is the game that updates only first rank Rk1, whereas the second game is the game that updates first level parameter Lp1 in addition to first rank Rk1.

In second application A2, the third game is the game that can increase at least second rank Rk2 relating to user play. In other words, the third game updates second rank Rk2 relating to user play. The fourth game is the game that can increase at least second rank Rk2 relating to user play and second level parameter Lp2 indicating the skill of the user. In other words, the fourth game updates second rank Rk2 and second level parameter Lp2. Thus, also in second application A2, the third game is the game that updates only second rank Rk2, whereas the fourth game is the game that updates second level parameter Lp2 in addition to second rank Rk2.

[E. As to Condition for Execution of Second Game]

As described with reference to FIG. 1, the second game is the communication game executable when the execution condition is satisfied. When processor 102 determines that the execution condition is satisfied at the time of execution of second game execution program 114, it sets second game execution flag FL1 described with reference to FIG. 3 to “ON”.

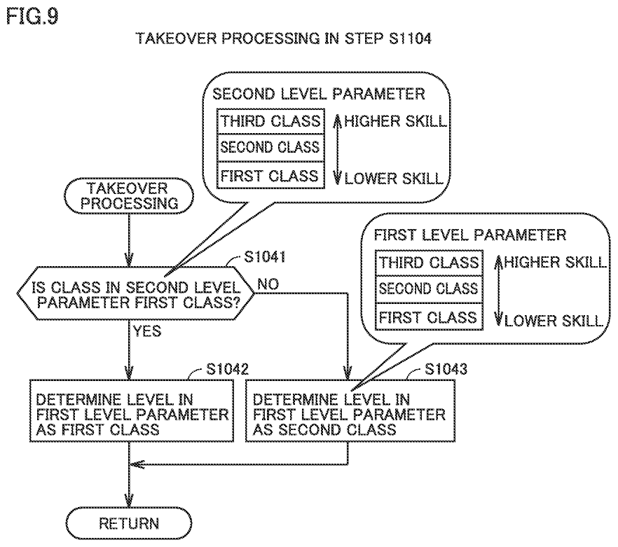

Processor 102 performs takeover processing and determination processing by executing second game execution program 114. The takeover processing will be described in detail with reference to FIG. 9. The determination processing is processing for determining whether or not there is a record on second application A2 and setting second game execution flag FL1.

In the present embodiment, processor 102 uses at least one of a first condition and a second condition for determining whether or not the condition for execution of the second game is satisfied. The first condition is a condition that first rank Rk1 is equal to or higher than “rank 10” as described above. Processor 102 obtains the value of first rank Rk1 and determines whether or not the value is equal to or higher than “rank 10.” When first rank Rk1 is equal to or higher than “rank 10,” processor 102 determines that the first condition is satisfied.

The second condition is a condition that there is a record on second application A2. The record on second application A2 refers to a record indicating at least the fact of execution of second application A2 in the present embodiment. The record indicating at least the fact of execution of second application A2 is information indicating that the user has executed the second application. In the present embodiment, the record indicating at least the fact of execution of second application A2 is second user information F2 stored in server 200. In another embodiment, second user information F2 may be stored in terminal 100. Various types of save data stored in terminal 100 or server 200 may be used as the record indicating at least the fact of execution of second application A2.

In the present embodiment, processor 102 determines whether or not it can refer to second user information F2. As described above, a user can access only second user information F2 corresponding to the user himself/herself. Therefore, when processor 102 can refer to second user information F2, it suggests that the user who executes first application A1 have an experience of execution of second application A2.

Thus, when it is determined that there is a record on second application A2, it means that the second condition is satisfied. When processor 102 determines that at least one of the first condition and the second condition is satisfied, it sets second game execution flag FL1 to “ON”, regarding the condition for execution of the second game as being satisfied. Thus, in the present embodiment, in first application A1 that provides the communication game, the user who has the experience in the game provided by second application A2 can execute the second game early.

In other words, the user who has the experience in the game can execute the second game without the need to increase first rank Rk1. Furthermore, in the present embodiment, when the second game is executable as a result of satisfaction of the second condition, the value of first rank Rk1 remains at “rank 1” which is the initial value. Zest of increase in first rank Rk1 from “rank 1” to “rank 10” is thus not compromised. Since the degree of difficulty in increase in first rank Rk1 from “rank 1” to “rank 10” is relatively low as described above, the user can easily increase first rank Rk1.

[F. Processing Procedure]

<F1. Main Processing>

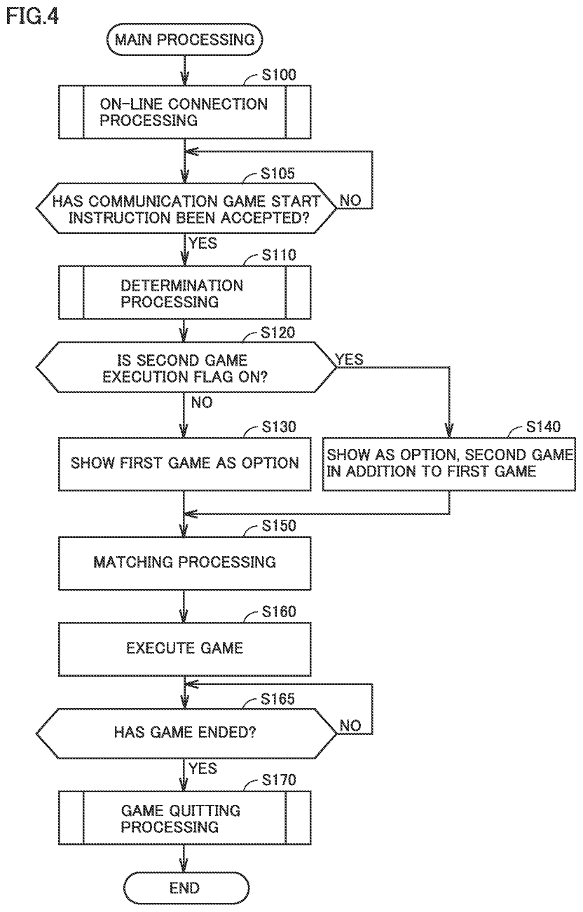

FIG. 4 is a flowchart showing a procedure in main processing. In the present embodiment, the flowchart shown in FIG. 4 and later is implemented by execution of system program 111, first game execution program 113, or second game execution program 114 by processor 102. For example, off-line game processing may be performed in parallel, other than the main processing shown in FIG. 4.

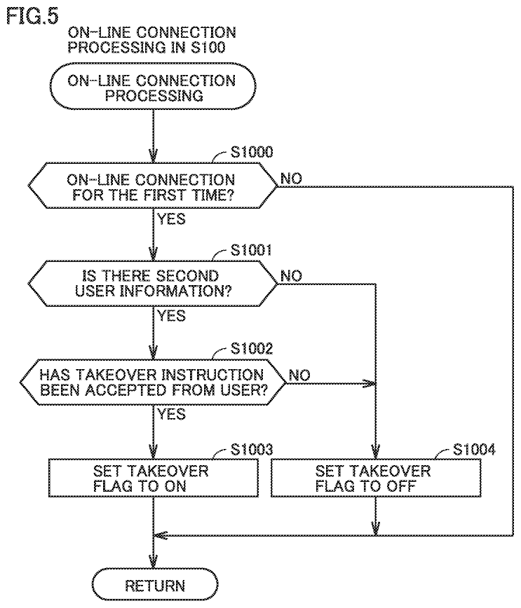

The flowchart shown in FIG. 4 is performed in response to start-up of first application A1. Processor 102 performs on-line connection processing (step S100). Details of the on-line connection processing will be described in detail with reference to FIG. 5.

Processor 102 determines whether or not it has accepted a communication game start instruction (step S105). Specifically, processor 102 accepts the communication game start instruction from the user through operation portion 108. The communication game start instruction is generated, for example, by an operation to make transition to a communication game acceptance screen by the user or movement of a virtual user to a communication game reception venue in the virtual space.

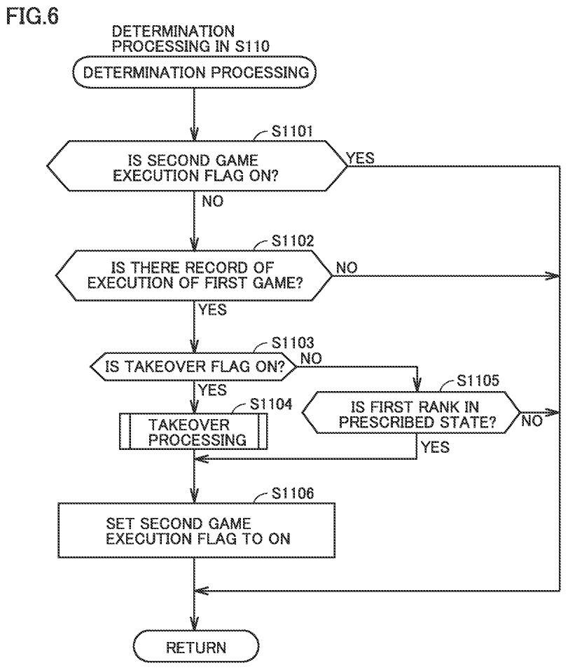

When processor 102 determines that it has not accepted the communication game start instruction (NO in step S105), it repeats processing in step S105. When processor 102 determines that it has accepted the communication game start instruction (YES in step S105), it performs determination processing (step S110). Details of the determination processing will be described in detail with reference to FIG. 6.

Processor 102 determines whether or not second game execution flag FL1 has been set to “ON” (step S120). When second game execution flag FL1 has not been set to “ON” (NO in step S120), processor 102 has the first game shown as an option for an executable game (step S130). The user can execute the first game by selecting the first game through operation portion 108.

When second game execution flag FL1 has been set to “ON” (YES in step S120), processor 102 has the second game in addition to the first game shown as options for executable games (step S140). The user selects the first game or the second game through operation portion 108 and processor 102 executes the game corresponding to the selected game. In step S130 or 140, processor 102 may have an option shown for canceling execution of the communication game.

After processor 102 accepts the option selected by the user from the options shown in step S130 or 140, it performs matching processing (step S150). Specifically, after one of the “first game” and the “second game” is selected, in step S150, processor 102 performs processing for matching with a user in the same class in first level parameter Lp1. In first application A1, a match between users comparable in skill is realized.

Processor 102 executes the game corresponding to the selected game (step S160). When “cancel communication game” is selected, processor 102 quits the flowchart in FIG. 4 without performing processing in steps S165 and 170. After the game is executed, processor 102 determines whether or not the executed game has ended (step S165).

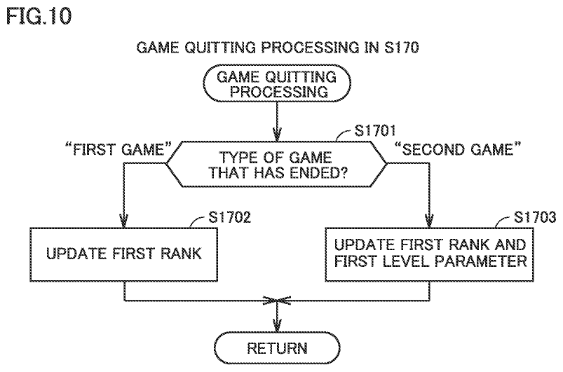

When the game has not yet ended (NO in step S165), processor 102 repeats processing in step S165. When the processor determines that the game has ended (YES in step S165), the processor performs game quitting processing (step S170). Details of the game quitting processing will be described in detail with reference to FIG. 10.

Thus, in first application A1 in the present embodiment, a type of a game shown as an option is changed based on a value set for second game execution flag FL1. Specifically, when second game execution flag FL1 has been set to “OFF”, the second game is not shown as the option. When second game execution flag FL1 has been set to “ON”, the second game is shown as the option.

<F2. On-Line Connection Processing>

FIG. 5 is a flowchart showing a procedure in on-line connection processing. As described with reference to FIG. 4, processor 102 performs the on-line connection processing after it starts up first application A1. When the on-line connection processing is started, processor 102 is connected to server 200 through communication unit 120.

Processor 102 determines whether or not the on-line connection processing in FIG. 5 is on-line connection for the first time (step S1000). On-line connection for the first time refers to the first on-line connection after execution for the first time of first application A1 by a specific user. When the on-line connection processing is not on-line connection for the first time (NO in step S1000), processor 102 quits the on-line connection processing. Processor 102 may determine whether or not the on-line connection processing is the on-line connection for the first time, for example, based on whether or not there is first user information F1 corresponding to the user who is executing first application A1 in server 200. When first user information F1 of the user is not stored in server 200 in spite of the on-line connection for the first time, server 200 may generate first user information F1.

When the on-line connection processing is the on-line connection for the first time (YES in step S1000), processor 102 determines whether or not there is second user information F2 (step S1001). More specifically, processor 102 determines whether or not there is second user information corresponding to the user who is executing the first application in server 200 (step S1001).

When there is no second user information (NO in step S1001), processor 102 sets takeover flag FL2 to “OFF” (step S1004) and quits the process. When there is second user information (YES in step S1001), processor 102 has a dialog shown for asking the user whether to perform takeover processing, and thereafter determines whether or not it has accepted a takeover instruction from the user (step S1002). The dialog is representation asking the user whether or not to take over to first application A1, data generated as a result of execution of second application A2.

When processor 102 has not accepted the takeover instruction from the user (NO in step S1002), it sets takeover flag FL2 to “OFF” (step S1004) and quits the process. When processor 102 has accepted takeover instruction from the user (YES in step S1002), it sets takeover flag FL2 to “ON” (step S1003) and quits the process.

Thus, in system 10 in the present embodiment, when the user agrees with takeover after on-line connection for the first time after start-up of first application A1, takeover flag FL2 is set to “ON”. When takeover flag FL2 has already been set to “ON”, processor 102 does not have to perform the on-line connection processing itself shown in FIG. 5.

<F3. Processing for Setting Second Game Execution Flag>

FIG. 6 is a flowchart showing a procedure in processing for setting the second game execution flag. In first application A1 in the present embodiment, whether or not to set the second game execution flag to “ON” is determined in determination processing in S110. As described with reference to FIG. 4, processor 102 performs the determination processing (step S110) after it accepts the communication game start instruction. Processor 102 determines whether or not the second game execution flag has already been set to “ON” (step S1101).

When the second game execution flag has already been set to “ON” (YES in step S1101), processor 102 quits the process. When the second game execution flag has not been set to “ON” (NO in step S1101), the processor determines whether or not there is a record of execution of the first game (step S1102). When the first game has never been executed, in spite of presence of data to be taken over, processor 102 quits the process without setting the second game execution flag to “ON”. Even when an action or an operation method of first application A1 is common to an action or an operation method of second application A2, first application A1 and second application A2 are different from each other, and first application A1 may include a specific action or operation method that cannot be performed in second application A2. Therefore, the first game also plays a role as a tutorial with which a basic operation method can be learnt in play of first application A1 as described above.

When there is a record of execution of the first game (YES in step S1102), processor 102 determines whether or not takeover flag FL2 has been set to “ON” (step S1103). When takeover flag FL2 has been set to “ON” (YES in step S1103), processor 102 performs takeover processing (step S1104). Details of the takeover processing will be described in detail with reference to FIG. 9.

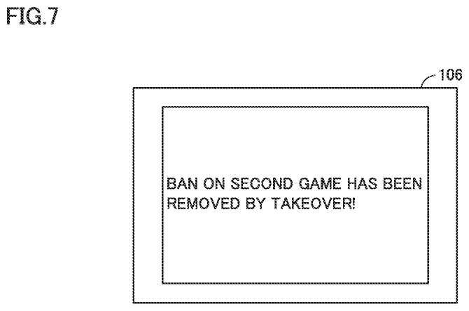

After the takeover processing is performed, processor 102 sets second game execution flag FL1 to “ON” (step S1106). The user can thus execute the second game as a result of takeover of data in second application A2. After the takeover processing is performed, processor 102 may set takeover flag FL2 to “OFF”. FIG. 7 shows an exemplary screen showing that ban on execution of the second game has been removed as a result of the takeover processing. When second game execution flag FL1 is set to “ON” as a result of the takeover processing, processor 102 has a screen in FIG. 7 shown on display 106 in step S1106.

Referring back to step S1103, when the takeover flag has not been set to “ON” (NO in step S1103), processor 102 determines whether or not first rank Rk1 is in a prescribed state (step S1105). Specifically, processor 102 determines whether or not first rank Rk1 is equal to or higher than “rank 10.” First rank Rk1 increases based on execution of the first game as described above. In step S1105, whether or not the user has increased first rank Rk1 to “rank 10” in the first game is determined.

When first rank Rk1 is lower than “rank 10” (NO in step S1105), processor 102 quits the process without setting second game execution flag FL1 to “ON”. When first rank Rk1 is equal to or higher than “rank 10” (YES in step S1105), processor 102 sets second game execution flag FL1 to “ON” (step S1106). The user can thus execute the second game as a result of first rank Rk1 reaching “rank 10.”

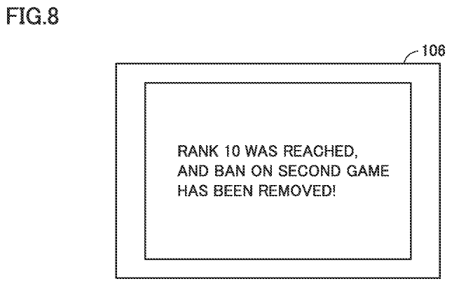

FIG. 8 shows an exemplary screen showing that ban on execution of the second game has been removed as a result of first rank Rk1 reaching “rank 10.” When processor 102 sets second game execution flag FL1 to “ON” as a result of first rank Rk1 reaching “rank 10,” it has a screen in FIG. 8 shown on display 106 in step S1106.

As shown in FIGS. 6 to 8, at least when first rank Rk1 is equal to or higher than rank 10 or at least when it is determined that there is a record on second application A2, system 10 in the present embodiment sets second game execution flag FL1 to “ON.” System 10 can thus provide a scheme for allowing a user estimated to have an experience in the game to execute the second game early while it allows a less experienced user to learn basic operations and rules before the user executes the second game, in first application A1 that provides the communication game. In other words, the scheme for allowing the user estimated to have the experience in the game to execute the specific game early can be realized.

<F4. Takeover Processing>

FIG. 9 is a flowchart showing a procedure in the takeover processing. In the takeover processing, processing for taking over a level parameter indicating the skill of the user is performed. Specifically, in system 10, the skill of the user in second application A2 is reflected on first level parameter Lp1 indicating the skill of the user in first application A1. In other words, processor 102 generates first level parameter Lp1 with second level parameter Lp2 being defined as the reference.

As described with reference to FIG. 6, when processor 102 has set takeover flag FL2 to “ON”, it performs the takeover processing. As described above, in the present embodiment, the data type of first level parameter Lp1 falls under the data type including such classes as the first class, the second class, and the third class. Second level parameter Lp2 is identical in data type to first level parameter Lp1. As shown in FIG. 9, in each of first level parameter Lp1 and second level parameter Lp2, the first class is the class indicating the lowest skill and the third class is the class indicating the highest skill. The second class is the class indicating the skill intermediate between the first class and the third class.

In the takeover processing, processor 102 determines whether or not the “first class” has been set in second level parameter Lp2 defined as the reference (step S1041). Specifically, in step S1041, whether or not the first class indicating the lowest skill has been set in second level parameter Lp2 indicating the skill of the user in second application A2 is determined. When the first class indicating the lowest skill has been set in second level parameter Lp2 (YES in step S1041), processor 102 sets the class in first level parameter Lp1 to the first class (step S1042) and quits the process. In other words, when the class indicating the lowest skill has been set in second level parameter Lp2 in second application A2, processor 102 sets the class indicating the lowest skill also in first level parameter Lp1 in first application A1.

When the first class indicating the lowest skill has not been set in second level parameter Lp2 (NO in step S1041), processor 102 set the class in first level parameter Lp1 to the second class (step S1043) and quits the process.

Processor 102 thus determines the class in the first level parameter of the user based on information on the second level parameter. Thus, in system 10, the skill of the user in second application A2 can be reflected on first level parameter Lp1 indicating the skill of the user in first application A1. When the class in second level parameter Lp2 has not been set to the first class which is the lowest, processor 102 determines the value of first level parameter Lp1 as the second class higher than the lowest class and lower than the highest class.

<F5. Game Quitting Processing>

FIG. 10 is a flowchart showing a procedure in game quitting processing. Update of first rank Rk1 and update of first level parameter Lp1 performed in game quitting processing will be described below. As described with reference to FIG. 4, after processor 102 executes the game, it executes the game quitting processing (step S170). For example, when at least one of teams satisfies the winning condition set for the game or when a time limit set for the game has been exceeded, quitting processing is performed. Processor 102 determines a type of the game that has ended (step S1701). When the type of the game that has ended falls under the first game, processor 102 updates first rank Rk1 (step S1702). Update of first rank Rk1 may include lowering in first rank Rk1 in addition to increase in first rank Rk1.

For example, processor 102 may increase or lower first rank Rk1 based on contents in the first game. Specifically, when the user wins the first game, processor 102 may increase first rank Rk1, and when the user loses the first game, processor 102 may lower first rank Rk1. Alternatively, processor 102 may determine to increase or lower first rank Rk1 based on contribution by the user to the first game regardless of whether or not the user has won or lost the game.

When the type of the game that has ended falls under the second game, processor 102 updates first rank Rk1 and first level parameter Lp1 (step S1703). As in update of first rank Rk1 in the first game, also in the second game, first rank Rk1 may not only increase but also lower.

Update of first level parameter Lp1 may also include lowering in first level parameter Lp1 in addition to increase in first level parameter Lp1. For example, processor 102 may increase or lower first level parameter Lp1 based on contents in the second game. Specifically, when the user wins the second game, processor 102 may increase first level parameter Lp1, and when the user loses the second game, processor 102 may lower first level parameter Lp1. Alternatively, processor 102 may not only increase but also lower first level parameter Lp1 based on contribution by the user to the second game, regardless of whether or not the user has won or lost the game.

Furthermore, first level parameter Lp1 may lower based on lapse of a prescribed period regardless of execution of the second game. For example, each time one month elapses, processor 102 lowers the class in first level parameter Lp1 to a class lower by one. In first application A1, first level parameter Lp1 of all users can thus be lowered as the prescribed period elapses, regardless of the degree of the skill of each user.

[G. Representation of Rank]

First application A1 is configured to show first rank Rk1 of the user to another user. For example, in the virtual space, a virtual user is provided with first rank Rk1. Alternatively, first ranks Rk1 of users are mutually shown while the first game or the second game is executed. In first application A1, users can thus recognize first rank Rk1.

When the second game is executable as a result of the takeover processing as described above, the user, first rank Rk1 of which is lower than rank 10, executes the second game. Consequently, in first application A1, another user can know that the user has the experience in the second application.

Furthermore, first application A1 may be configured such that first level parameter Lp1 of the user is shown to another user similarly to first rank Rk1. When first level parameter Lp1 is shown to another user and when first rank Rk1 is lower than “rank 10” and the class in first level parameter Lp1 is set for the user, it suggests that the user has the experience in the game in second application A2.

[H. Other Forms]

Other forms resulting from partial modification to the embodiment described above will be described below.

<H1. Processing in Server 200>

In the present embodiment, the configuration in which server 200 manages user information is described. At least a part of processing performed by processor 102 of terminal 100, however, may be performed by server 200. More specifically, for example, terminal 100 may simply accept input from the user and show an image, and server 200 may perform other processing such as the flowchart described with reference to FIG. 4 or later. Specifically, most part of processing necessary for the communication game may be performed on the cloud, and terminal 100 may accept an operation and show an image and may communicate with server 200 for accepting the operation and showing the image. Server 200 is not limited to a single server, and may be implemented by one or more other apparatuses arranged as being distributed over the network. In other words, processing for executing the communication game may be performed by a plurality of apparatuses as being distributed.

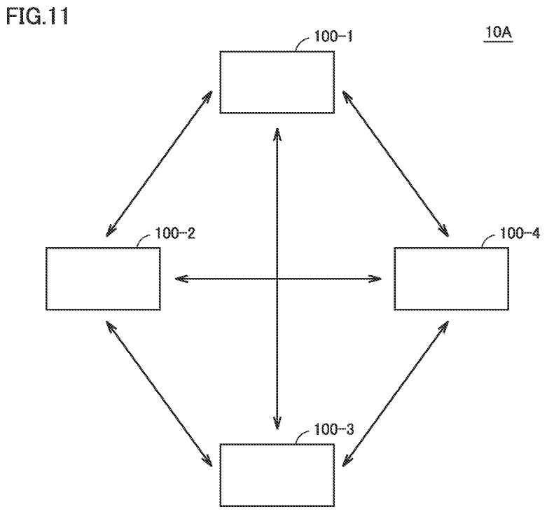

System 10 does not have to include server 200. FIG. 11 is a schematic diagram showing another exemplary system according to the present embodiment. In a system 10A shown in FIG. 11, at least one terminal 100 may be a “master” that manages the communication game and another terminal 100 may be a “slave” that performs processing under the management by the “master”. In other words, terminal 100 as the “master” behaves like server 200 in the present embodiment.

In system 10A shown in FIG. 11, communication for exchange of data among terminals 100-1 to 100-4 may be wired communication or wireless communication. In the example shown in FIG. 11, second user information F2 is stored in terminal 100 itself.

<H2. First Application A1 and Timing of Release of First Application A1>

The configuration in which second application A2 is released earlier than first application A1 is described in the present embodiment. Second application A2, however, may be released at the same time as first application A1. For example, first application A1 and second application A2 may be applications that belong to the same series but are different in version as being slightly different in details of games, although the games are generally the same in specifications.

<H3. As to Rank and Level Parameter>

In the present embodiment, the configuration in which the degree of difficulty in increase in first rank Rk1 is higher each time first rank Rk1 increases by one is described. In first application A1, however, the degree of difficulty in increase in first rank Rk1 by one may become higher at prescribed timing such as timing when “rank 20” or “rank 30” is reached. The prescribed timing refers, for example, to timing of carry of the tens place of the rank. The prescribed timing is not limited to the timing of carry of the tens place of the rank, and it may be other timing such as timing of the rank reaching a multiple of five. In another embodiment, the degree of difficulty in increase in first rank Rk1 by one does not necessarily have to increase, and the degree of difficulty in increase in first rank Rk1 by one may be the same regardless of the value of first rank Rk1.

Though a method of expressing first rank Rk1 with a numeric value and expressing first level parameter Lp1 with a class is described in the present embodiment, the method of expressing each parameter is not limited as such. The method of expressing each parameter may use such characters as “gold”, “silver”, and “bronze” and may use both of characters and numerals such as “skilled player level 1” or “beginner level 5.”

<H4. As to Condition for Execution of Second Game>

In the present embodiment, the first condition as the condition for execution of the second game is described as first rank Rk1 reaching “rank 10” or higher and the second condition as the condition for execution of the second game is described as presence of a record on second application A2.

The first condition, however, is not limited to first rank Rk1 reaching “rank 10” or higher, and it may be first rank Rk1 reaching “rank 20” or “rank 30” or first rank Rk1 reaching another prescribed numeric value.

In the present embodiment, when processor 102 is able to refer to second user information F2, it determines that there is a record on second application A2 and that the second condition is satisfied. In other words, the second condition in the present embodiment refers to a condition that the processor is able to refer to second user information F2.

The second condition, however, is not limited to the condition that the processor is able to refer to second user information F2. For example, the second condition may be presence in second user information F2, of data indicating that the fourth game has been executable. For example, when the condition for execution of the fourth game is defined as a condition that second rank Rk2 is equal to or higher than “rank 10,” the second condition may be defined as a condition that second rank Rk2 shown in second user information F2 is equal to or higher than “rank 10.”

As described above, a user can access only second user information F2 corresponding to the user himself/herself. Therefore, when second rank Rk2 in second user information F2 that has been referred to is equal to or higher than “rank 10,” it suggests that the user has the experience of execution of the fourth game in second application A2.

Alternatively, the second condition may be defined as a condition that second user information F2 indicates data that the third game was executed at least once. Alternatively, the second condition may be defined as a condition that second level parameter Lp2 in second user information F2 reaches a prescribed class. In other words, processor 102 does not check only presence of second user information F2 for determining whether or not the second condition is satisfied, but may use whether or not information in second user information F2 satisfies a prescribed condition.

The second condition may be defined as presence of information indicating possession of second application A2 by the user. Information indicating possession of second application A2 by the user may be, for example, a history of purchase indicating on-line purchase if application data of second application A2 has been purchased on-line. Alternatively, the information indicating possession of second application A2 may be a history of attachment indicating attachment to terminal 100, of an externally attachable recording medium where data for execution of second application A2 is stored.

<H5. As to Takeover Processing>

As described with reference to FIG. 9, in the takeover processing in the present embodiment, first level parameter Lp1 is determined based on second level parameter Lp2. In other forms, however, in the takeover processing, first rank Rk1 may be determined based on second rank Rk2. In other words, in system 10 in other forms, second rank Rk2 is taken over to first rank Rk1. In system 10 in other forms, only the rank may be taken over or both of the rank and the level parameter may be taken over. The record of execution of a game under the same series can be reflected on a parameter in another application under the same series.

[I. Advantages]

Thus, in system 10 according to the present embodiment, when first rank Rk1 is equal to or higher than “rank 10” or when there is a record on second application A2, second game execution program 114 determines that the condition for execution of the second game is satisfied. Thus, in system 10 according to the present embodiment, in first application A1 that provides the communication game, the user who has the experience in a game that allows execution of the fourth game in second application A2 is allowed to execute the second game early.

In other words, the user who has the experience in the game can execute the second game without the need to increase first rank Rk1. Furthermore, the value of first rank Rk1 in execution of the second game by the user who has the experience in the game remains at “rank 1” which is the initial value. Zest of increase in first rank Rk1 from “rank 1” to “rank 10” is thus not compromised. Since the degree of difficulty in increase in first rank Rk1 from “rank 1” to “rank 10” is low as described above, the user can easily increase first rank Rk1.

As described with reference to FIG. 6, processor 102 determines whether or not there is a record of execution of the first game in step S1102. Thus, in system 10 in the present embodiment, the user who has the experience in second application A2 can be allowed to execute the second game after the user executes the first game in first application A1 different from second application A2.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A non-transitory computer-readable storage medium with an executable program stored thereon, the program causing one or more processors to execute a first application including at least a first game and a second game based on communication between/among a plurality of users, the program causing the one or more processors to perform:
executing the first game that at least increases a first parameter relating to user play;
executing the second game when an execution condition is satisfied;
performing determination as to whether there is a record at least indicating possession or execution by a user of a second application different from the first application; and
determining that the execution condition is satisfied at least when the first parameter is in a prescribed state or at least when it is determined that the record is present.

2. The non-transitory computer-readable storage medium according to claim 1, wherein
the second application comprises a third game and a fourth game based on communication between/among the plurality of users,
the third game increases a second parameter relating to user play, and
the fourth game is executable when the second parameter is in a prescribed state.

3. The non-transitory computer-readable storage medium according to claim 2, wherein
the program causes the one or more processors to perform determining that the execution condition is satisfied regardless of whether the record indicates that the fourth game has been executable by the user.

4. The non-transitory computer-readable storage medium according to claim 2, wherein
the second game
at least increases a first level parameter indicating a skill of a user with a plurality of classes, and
is executed by matching of users in an identical class of the first level parameter,
the fourth game
at least increases a second level parameter indicating a skill of a user with a plurality of classes, and
is executed by matching of users in an identical class of the second level parameter,
the record includes information on the second level parameter, and
the program causes the one or more processors to perform determining a class in the first level parameter of a user based on the information on the second level parameter.

5. The non-transitory computer-readable storage medium according to claim 4, wherein
the program causes the one or more processors to perform determining, when a class in the second level parameter included in the record is not a lowest class among the plurality of classes, the class in the first level parameter as a prescribed class higher than the lowest class and lower than a highest class among the plurality of classes.

6. The non-transitory computer-readable storage medium according to claim 1, wherein
the program causes the one or more processors to perform determining that the execution condition is satisfied when it is determined that the record is present and furthermore when the user executed the first game at least once.

7. A system that executes a first application including at least a first game and a second game based on communication between/among a plurality of users, the system comprising:
a memory storing a computer-readable program; and
one or more processors that perform, when executing the computer-readable program,
executing the first game that at least increases a first parameter relating to user play,
executing the second game when an execution condition is satisfied,
determining whether there is a record at least indicating possession or execution by a user of a second application different from the first application, and
determining that the execution condition is satisfied at least when the first parameter is in a prescribed state or at least when it is determined that the record is present.

8. The system according to claim 7, wherein
the second application comprises a third game and a fourth game based on communication between/among the plurality of users,
the third game increases a second parameter relating to user play, and
the fourth game is executable when the second parameter is in a prescribed state.

9. The system according to claim 8, wherein
one or more processors perform, when executing the computer-readable program, determining that the execution condition is satisfied regardless of whether the record indicates that the fourth game has been executable by the user.

10. The system according to claim 8, wherein
the second game
at least increases a first level parameter indicating a skill of a user with a plurality of classes, and
is executed by matching of users in an identical class of the first level parameter,
the fourth game
at least increases a second level parameter indicating a skill of a user with a plurality of classes, and
is executed by matching of users in an identical class of the second level parameter,
the record includes information on the second level parameter, and
one or more processors perform, when executing the computer-readable program, determining a class in the first level parameter of the user based on the information on the second level parameter.

11. The system according to claim 10, wherein
one or more processors perform, when executing the computer-readable program, determining, when a class in the second level parameter included in the record is not a lowest class among the plurality of classes, the class in the first level parameter as a prescribed class higher than the lowest class and lower than a highest class among the plurality of classes.

12. The system according to claim 7, wherein
one or more processors perform, when executing the computer-readable program, determining that the execution condition is satisfied when it is determined that the record is present and furthermore when the user executed the first game at least once.

13. A method of causing one or more processors to execute a first application including at least a first game and a second game based on communication between/among a plurality of users, the method comprising:
executing the first game that at least increases a first parameter relating to user play;
executing the second game when an execution condition is satisfied;
determining whether there is a record at least indicating possession or execution by a user of a second application different from the first application; and
determining that the execution condition is satisfied at least when the first parameter is in a prescribed state or at least when it is determined that the record is present.

14. The method according to claim 13, wherein
the second application comprises a third game and a fourth game based on communication between/among the plurality of users,
the third game increases a second parameter relating to user play, and
the fourth game is executable when the second parameter is in a prescribed state.

15. The method according to claim 14, comprising determining that the execution condition is satisfied regardless of whether the record indicates that the fourth game has been executable by the user.

16. The method according to claim 14, wherein
the second game
at least increases a first level parameter indicating a skill of a user with a plurality of classes, and
is executed by matching of users in an identical class of the first level parameter,
the fourth game
at least increases a second level parameter indicating a skill of a user with a plurality of classes, and
is executed by matching of users in an identical class of the second level parameter,
the record includes information on the second level parameter, and
the method comprises determining a class in the first level parameter of the user based on the information on the second level parameter.

17. The method according to claim 16, comprising determining, when a class in the second level parameter included in the record is not a lowest class among the plurality of classes, the class in the first level parameter as a prescribed class higher than the lowest class and lower than a highest class among the plurality of classes.

18. The method according to claim 13, comprising determining that the execution condition is satisfied when it is determined that the record is present and furthermore when the user executed the first game at least once.
